(19) United States
(12) Patent Application Publication
(10) Pub. No.: US 2015/0294405 A1
(43) Pub. Date: Oct. 15, 2015

(54) VIRTUAL BANKING CENTER

(71) Applicant: Bank of America Corporation, Charlotte, NC (US)

(72) Inventors: Carrie Anne Hanson, Charlotte, NC (US); Richard Andrew Starbuck, Walnut Creek, CA (US); David M. Grigg, Rock Hill, SC (US); Alicia C. Jones, Fort Mill, SC (US); Audrey L. Longfellow, Oak Hill, VA (US)

(73) Assignee: BANK OF AMERICA CORPORATION, CHARLOTTE, NC (US)

(21) Appl. No.: 14/250,997

(22) Filed: Apr. 11, 2014

(51) Int. Cl. G06Q 40/02

(52) U.S. Cl. CPC G06Q 40/02

(57) ABSTRACT

Systems, apparatus, methods, and computer program products are provided for a virtual banking experience using a wearable computing device. Embodiments of the invention involve a memory device; and a processing device operatively coupled to a memory; a computing processor; and a module configured to cause the one or more computing processors to receive an indication that the customer desires to initiate a virtual banking session using the OHMD; receive from the customer a selection of a real agent or a virtual agent for conducting the virtual banking session; configure a virtual banking environment comprising one or more virtual objects for facilitating the virtual banking session, wherein the virtual banking environment comprises one or more virtual objects associated with one or more financial institution products and/or services; and implement, via the OHMD, the virtual banking session involving the customer and the customer-selected real agent or the customer-selected virtual agent.

### FIELD

In general, embodiments of the invention relate to configuring a virtual banking environment to enable a customer execute one or more financial institution transactions in a partitioned area via an optical head mounted display.

### BACKGROUND

Banks and other financial institutions seek to continually improve the customer banking experience through the use of technology. Recent innovations in the mobile technologies space have advanced the efforts of banks and other financial institutions in improving accessibility to offered services and overall convenience.

However, many of these recent innovations may lack an aspect of interactivity with the bank or bank personnel that many customers would like to experience. As such, a need exists for an invention that overcomes the deficiencies of the current systems and methods.

### BRIEF SUMMARY

Embodiments of the present invention address the above needs and/or achieve other advantages by providing apparatuses (e.g., a system, computer program product, and/or other device) and methods for providing a virtual banking experience using a wearable computing device.

Embodiments of the invention include systems, computer program products, and methods for providing a virtual banking experience using a wearable computing device, whereby the wearable computing device allows the customer to interact with a financial institution. Specific embodiments of the invention comprises a system for providing a virtual banking experience using a wearable computing device, whereby the wearable computing device allows the customer to interact with a financial institution. The system comprises a wearable computer apparatus including one or more computing processors, a memory, and a display, wherein the wearable computer apparatus comprises an optical head-mounted display (OHMD) configured to present image information or multimedia information to the customer. In addition, a module stored in the memory, the module comprising computer-executable instructions that when executed by the one or more processors cause the system to receive an indication that the customer desires to initiate a virtual banking session using the OHMD and a customer selection of a real agent or a virtual agent for conducting the virtual banking session. In response to receiving the information, configure a virtual banking environment comprising one or more virtual objects for facilitating the virtual banking session, wherein the virtual banking environment comprises one or more virtual objects associated with one or more financial institution products and/or services, and implement, via the OHMD, the virtual banking session involving the customer and the customer-selected real agent or the customer-selected virtual agent.

In some embodiments, the system comprises a partitioned area providing a degree of privacy to the customer for conducting the virtual banking session, wherein the partitioned area comprises one or more OHMDs and one or more devices that are used in combination with the one or more OHMDs to facilitate the virtual banking session.

In some embodiments, the partitioned area is capable of communicating with one or more OHMDs not associated with the partitioned area, wherein communicating further comprises synchronizing the one or more OHMDs not associated with the partitioned area with the one or more devices to be used in combination with the one of more OHMDs not associated with the partitioned area to facilitate the virtual banking session.

In some embodiments, the partitioned area is capable of being dynamically set up and remotely connected to the financial institution.

In some embodiments, the module is further configured to receive, via the OHMD, authentication information from the customer authenticating the virtual banking session.

In some embodiments, the module is further configured to automatically populate the display with one or more virtual objects relating to one or more financial accounts of the customer based at least partially on receiving authentication information that successfully authenticates the customer.

In some embodiments, the one or more virtual objects relating to the one or more financial accounts of the customer are selectable within the virtual banking session by either the customer or the customer-selected real agent or the customer-selected virtual agent for conducting a transaction during the virtual banking session.

In some embodiments, the module is further configured to implement an unauthenticated virtual banking session, wherein only one or more virtual objects relating to information about products or services of the financial institution are populated to the display.

In some embodiments, the module is further configured to display the customer-selected real agent or the customer-selected virtual agent within the virtual banking environment, wherein the customer-selected real agent or the customer-selected virtual agent interact with the customer, and wherein the customer-selected real agent or the customer-selected virtual agent provide responses to one or more queries of the customer.

In some embodiments, the module is configured to enable customer-selected real agent to interact with the customer by at least one of a voice via a microphone, a video via a webcam, and/or an instant messaging client.

In one aspect, a method for providing a virtual banking experience using a wearable computing device, whereby the wearable computing device allows the customer to interact with a financial institution is presented, the method comprising: receiving, using a computing device processor, an indication that the customer desires to initiate a virtual banking session using the OHMD. In addition, the method comprises receiving, using a computing device processor, from the customer a selection of a real agent or a virtual agent for conducting the virtual banking session. In response, the method comprises configuring, using a computing device processor, a virtual banking environment comprising one or more virtual objects for facilitating the virtual banking session, wherein the virtual banking environment comprises one or more virtual objects associated with one or more financial institution products and/or services and implementing, using a computing device processor, via the OHMD, the virtual banking session involving the customer and the customer-selected real agent or the customer-selected virtual agent.

In some embodiments, configuring the virtual banking environment further comprises configuring a partitioned area for providing a degree of privacy to the customer for conducting the virtual banking session, wherein the partitioned area comprises one or more OHMDs and one or more devices that are used in combination with the one or more OHMDs to facilitate the virtual banking session.

In some embodiments, receiving further comprises receiving, via the OHMD, authentication information from the customer authenticating the virtual banking session.

In some embodiments, implementing further comprises implementing an unauthenticated virtual banking session, wherein only one or more virtual objects relating to information about products or services of the financial institution are populated to the display.

In some embodiments, configuring further comprises displaying the customer-selected real agent or the customer-selected virtual agent within the virtual banking environment, wherein the customer-selected real agent or the customer-selected virtual agent interact with the customer, and wherein the customer-selected real agent or the customer-selected virtual agent provide responses to one or more queries of the customer.

In some embodiments, implementing the virtual banking session further comprises enabling the customer-selected real agent to interact with the customer by at least one of a voice via a microphone, a video via a webcam, and/or an instant messaging client.

In another aspect, a computer program product for providing a virtual banking experience using a wearable computing device, whereby the wearable computing device allows the customer to interact with a financial institution, the computer program product comprising a non-transitory computer-readable medium comprising code causing a first apparatus to receive an indication that the customer desires to initiate a virtual banking session using the OHMD and a customer selection of a real agent or a virtual agent for conducting the virtual banking session. In response to receiving the information, configure a virtual banking environment comprising one or more virtual objects for facilitating the virtual banking session, wherein the virtual banking environment comprises one or more virtual objects associated with one or more financial institution products and/or services, and implement, via the OHMD, the virtual banking session involving the customer and the customer-selected real agent or the customer-selected virtual agent.

In some embodiments, the first apparatus is further configured to receive, via the OHMD, authentication information from the customer authenticating the virtual banking session.

In some embodiments, the first apparatus is further configured to implement an unauthenticated virtual banking session, wherein only one or more virtual objects relating to information about products or services of the financial institution are populated to the display.

In some embodiments, the first apparatus is further configured to automatically populate the display with one or more virtual objects relating to one or more financial accounts of the customer based at least partially on receiving authentication information that successfully authenticates the customer.

### BRIEF DESCRIPTION OF THE DRAWINGS

Having thus described embodiments of the invention in general terms, reference will now be made to the accompanying drawings, where:

FIG. 1 presents a general process flow for providing a virtual banking experience using a wearable computing device, in accordance with embodiments of the present invention.

FIG. 2 illustrates a process flow for presenting one or more products and services associated with a virtual object, in accordance with embodiments of the present invention.

FIG. 3 illustrates an exemplary block diagram of the system environment, in accordance with embodiments of the present invention.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a customer to establish an account with the entity. An “account” may be the relationship that the customer has with the entity. Examples of accounts include a deposit account, such as a transactional account (e.g. a banking account), a savings account, an investment account, a money market account, a time deposit, a demand deposit, a pre-paid account, a credit account, a non-monetary customer profile that includes only personal information associated with the customer, or the like. The account is associated with and/or maintained by an entity. In other embodiments, an “entity” may not be a financial institution.

In some embodiments, an “agent” may be a financial institution employee (e.g., an underwriter, a project manager, an IT specialist, a manager, an administrator, an internal operations analyst, bank teller, or the like). In one aspect, an agent may be capable of facilitating a transaction between the entity and a customer. In some embodiments, a “customer” may be a financial institution customer (e.g., an account holder or a person who have an account (e.g., banking account, credit account, or the like)). In some other embodiments, a customer may not be associated with the financial institution.

Virtual reality, in general, is a computer simulated environment that can simulate physical presence in places in the real world or imagined worlds. Most virtual reality environments are primarily visual experiences, displayed either on a computer screen or through wearable devices such as an optical head mounted display (OHMD), but some simulation include additional sensory information, such as sound through speakers or headphones. In some aspects, virtual reality covers remote communication environments which provide virtual presence of customers with the concepts of telepresence and telexistence or a visual artifact either through the use of standard input devices such as keyboard and mouse, or through multimodal devices such as a wired glove. For purposes of this invention, the virtually simulated environment is associated with a financial institution to provide a customer with a virtual banking experience using a wearable computing device.

In some embodiments, the wearable computing device may be an optical head-mounted display (OHMD). Typically, an OHMD is a personal information-viewing device including a wearable display that has the capability of reflecting projected images as well as allowing the customer to see through it. An OHMD may have either one or two small displays with lenses and semi-transparent mirrors embedded in a helmet, eye glasses, visor, or the like. In one aspect, OHMDs may be used in combination with one or more devices to initiate a customer experience with the system.

As used herein, a “virtual banking experience” may be defined as a platform for one or more services to be provided by the bank to a customer in a virtual environment. In some embodiments, the customer may select one or more services from the virtual banking environment to begin a virtual banking session. As used herein, a “virtual banking session” may be defined as an interaction between an agent and a customer based on a user selection of a particular service offered by the bank in the virtual banking environment from one or more services presented to the customer. In some embodiments, the virtual banking experience may be provided to a customer in a partitioned area providing a degree of privacy to the customer. Examples of partitioned areas include an interactive kiosk, an information terminal, a private booth, or the like. In some embodiments, the partitioned area may be a mobile kiosk capable of being dynamically set up and remotely connected to the back end server of the financial institution. In one aspect, the partitioned area may include one or more devices that may be used in combination with the OHMD to facilitate the service. In one aspect, the partitioned area may be within the confines of a banking environment. In another aspect, the partitioned area may not be within the confines of a banking environment.

In some embodiments, the customer may use an OHMD to begin the virtual banking experience. In one aspect, the OHMD may be a part of the partitioned area and already connected to one or more devices that may be used in combination with the OHMD. In another aspect, the customer may choose to use a personal OHMD capable of being synchronized to the partitioned area and the one or more devices required to facilitate a virtual banking session. In some embodiments, the customer may synchronize the personal OHMD to the partitioned area and the one or more devices using a wired connection or a wireless connection (WiFi, Bluetooth, near field communication, or the like) or a wired connection. In one aspect, synchronizing the personal OHMD with the partitioned area may automatically include synchronization with the one or more other devices required to facilitate a virtual banking session. In another aspect, the customer may have to synchronize the personal OHMD individually with partitioned area and the one or more devices individually to facilitate the virtual banking session. In response to synchronizing the OHMD with the partitioned area, the customer may initiate the virtual banking session. In some embodiments, the system may be configured to initiate the virtual banking environment on the customer's personal OHMD.

As illustrated, aspects of the present disclosure include methods, systems, and computer program products for providing a virtual banking experience. It will be appreciated that, although embodiments of the present invention are generally described in the context of virtual banking experience, the system may be applicable with other types of experiences that include customer interaction with an associate.

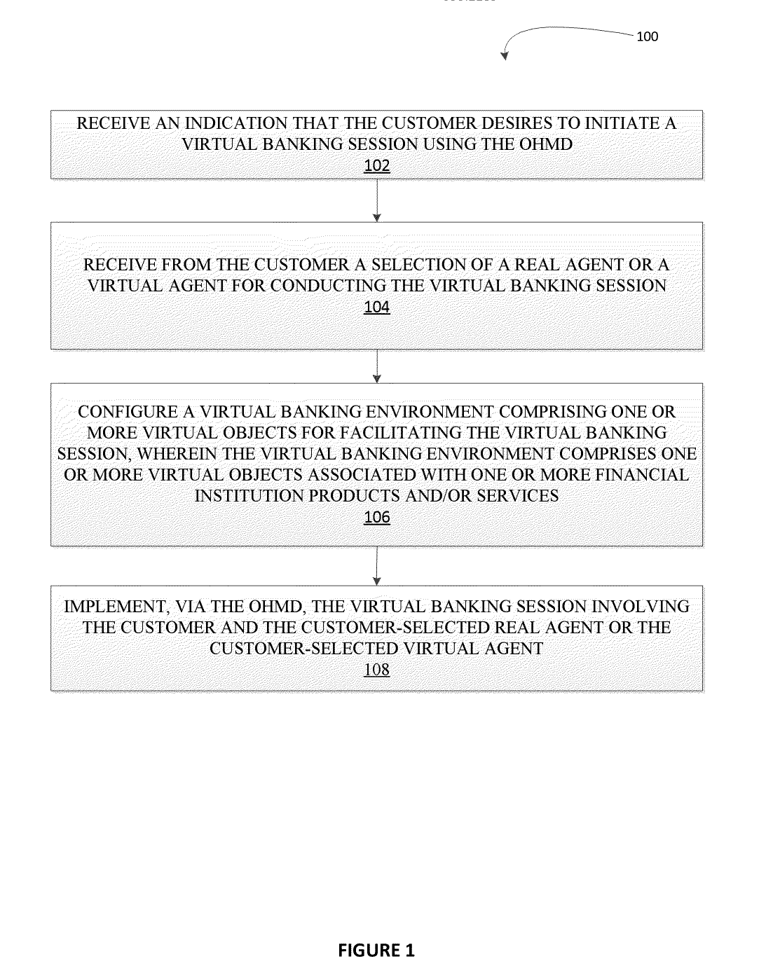

Referring now to FIG. 1, a general process flow for providing a virtual banking experience using a wearable computing device is presented. In some embodiments, the process flow includes receiving an indication that the customer desires to initiate a virtual banking session using the OHMD, as shown in block 102. In one aspect, the customer may initiate the virtual banking session by selecting one or more services offered by the virtual banking experience. The selection of one or more services may be based on one or more input devices associated with the partitioned area. For example, the selection of one or more services by the customer may be based on a touch input, a mouse click, a voice command, eyeball tracking using the OHMD, or the like.

In response to receiving the indication, the process flow includes receiving from the customer, a selection of a real agent or a virtual agent for executing the virtual banking session, as shown in block 104. In one aspect, a virtual agent may be a graphical representation of an agent in the virtual banking environment serving as a customer service representative for the financial institution. Typically, virtual agents have a human appearance and respond appropriately to customer questions. Combining artificial intelligence with a graphical representation, virtual agents are increasingly used in customer relationship management as they lend automated interactions a semblance of personal service. In some embodiments, the user selection of a real agent may include selecting an agent from a list of available agents. For example, the system may present to a user a list of one or more available agents at that particular time to enable a user to select an agent to initiate the virtual banking session. In some embodiments, the financial institution may preselect a virtual agent or a real agent to facilitate the banking session related to one or more specific virtual objects. In one aspect, the real agent may facilitate the virtual banking session through one or more devices associated with the partitioned area. For example, the real agent may facilitate the virtual banking session by virtue of a voice-over-IP (VOIP) service, whereby the real agent may communicate with the customer by voice using a microphone, video by using a webcam, an instant messaging client, and in certain instances, a combination of the three.

In response to receiving the customer selection of a real agent or a virtual agent, the process flow includes configure a virtual banking environment comprising one or more virtual objects for facilitating the virtual banking session, wherein the virtual banking environment comprises one or more virtual objects associated with one or more financial institution products and/or services, as shown in block 106. In some embodiments, configuring a virtual banking environment includes populating the customer's display with one or more virtual objects. In one aspect, the one or more virtual objects are one or more physical services available to a customer represented in the form of computer simulated graphical objects in a virtual banking session. For example, a virtual object may enable a customer access to one or more accounts associated with the customer. In some embodiments, each virtual object may include one or more virtual sub-objects. Each virtual sub-object may be configured to contain information associated with the one or more services offered by the financial institution. In some embodiments, the partitioned area can be configured to assist the customer to select/control such virtual objects by incorporating tactile sensors that measure forces exerted by the customer one the interface. In some other embodiments, the partitioned area can be configured to enable the selected real agent or the selected virtual agent to select/control the virtual objects for the customer. In some embodiments, the virtual banking environment may be customer specific. For example, the system may identify that the customer may be interested in the stock prices of specific companies. In such cases, the system may be configured to populate the virtual banking environment with the stock “tickers”. In another example, the system may be configured to process the customer's previous financial transactions and populate the virtual banking environment with one or more targeted offers.

Once the virtual banking environment is configured, the process flow includes implementing, via the OHMD, the virtual banking session involving the customer and the customer-selected real agent or the customer-selected virtual agent, as shown in block 108. In one aspect, the system may be configured to implement an authenticated virtual banking environment based on at least a successful customer authentication. The customer may be requested to present one or more authentication credentials to access information associated with one or more financial institution accounts associated with the customer. In some embodiments, the customer authentication may be received via the OHMD in the form of a retinal scan. In some other embodiments, the customer authentication may be received via alternative means such as a username/password entry, biometric authentication, token based authentication, or the like. In another aspect, the system may be configured to implement an unauthenticated virtual banking environment. In some embodiments, the customer may access general information regarding products and services available without being required to submit authentication credentials.

For example, a customer who is not associated with the financial institution may require information regarding one or more products and services associated with the financial institution. In such situations, the customer may enter a partitioned area and select a real agent to initiate the virtual banking session. As discussed earlier, the virtual banking session may be initiated using a wearable computer such as an OHMD. The system may then be configured initiate the virtual banking session by presenting one or more virtual objects to the customer. The customer may then interact with the real agent via the microphone whilst being given a virtual tour of the available products and services. In some cases, the customer may ask specific questions related to a particular product (e.g., navigating the online banking platform).

In another example, a customer who is associated with the financial institution may require assistance regarding one or more financial transactions associated with one or more financial accounts (e.g., checking, savings, investment, or the like). In such situations, the customer may enter a partitioned area and select a virtual agent to initiate the virtual banking session. As discussed earlier, the virtual banking session may be initiated using a wearable computer such as an OHMD. The system may then be configured to initiate the virtual banking session by presenting one or more virtual objects to the customer. The customer may interact with the virtual agent via the microphone while being directed to one or more virtual objects related to one or more financial transactions associated with the customer's financial account. The customer may either personally execute the financial transaction or have the transaction executed by the virtual agent facilitating the virtual banking session.

In some embodiments, the module may be configured to display the customer-selected real agent or the customer-selected virtual agent within the virtual banking environment. In one aspect, the customer-selected real agent may be displayed in the form of a real-time video stream and/or an avatar of the customer-selected real agent with the agent's voice over in real-time. In this way, the customer-selected real agent may interact with the customer and provide responses to one or more queries of the customer. In another aspect, the customer-selected virtual agent may be represented by an avatar with a pre-recorded voice programmed to play over the avatar.

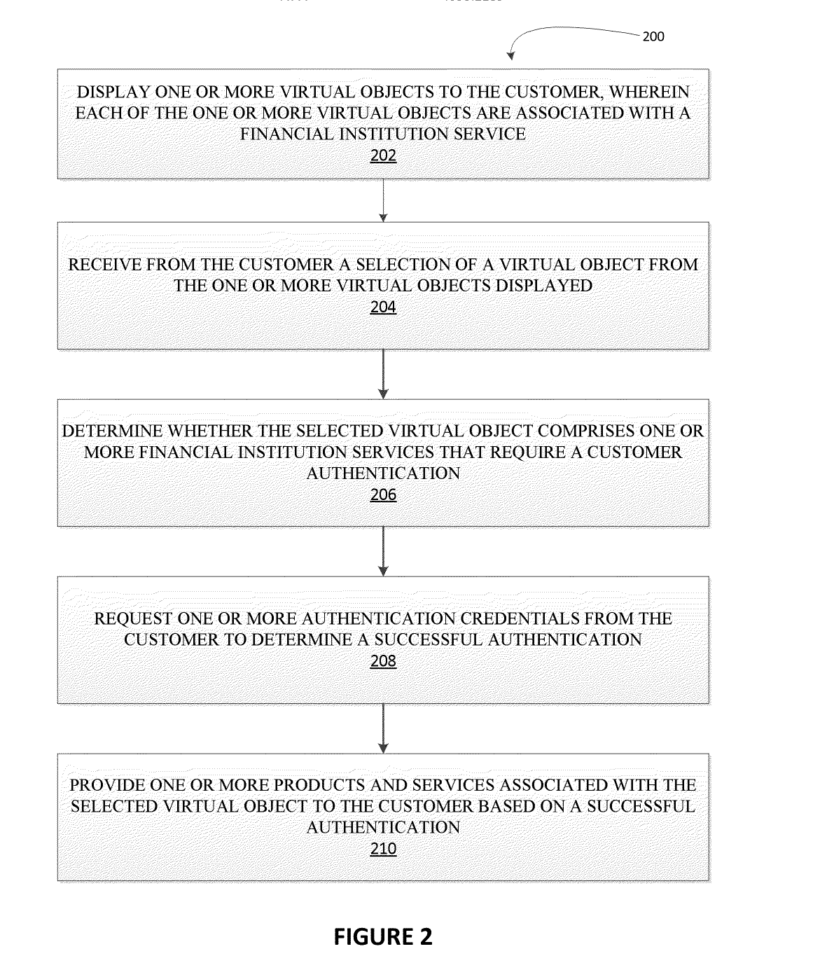

Referring now to FIG. 2, a process flow for presenting one or more products and services associated with a virtual object is presented. In some embodiments, the process flow includes displaying one or more virtual objects to the customer, wherein each of the one or more virtual objects are associated with a financial institution service, as shown in block 202. In response, the process flow includes receiving from the customer, a selection of a virtual object from the one or more virtual objects displayed, as shown in block 204. In response to receiving a selection, the process flow includes determining whether the selected virtual object comprises one or more financial institution services that require a customer authentication, as shown in block 206. In response, the process flow includes requesting one or more authentication credentials from the customer to determine a successful authentication, as shown in block 208. Once the authentication is deemed successful, the process flow includes providing one or more products and services associated with the selected virtual object to the customer, as shown in block 210. In some embodiments, one or more financial institution services include opening an account, accessing an existing account, transferring funds, applying for a loan/mortgage, access to investment banking, or the like.

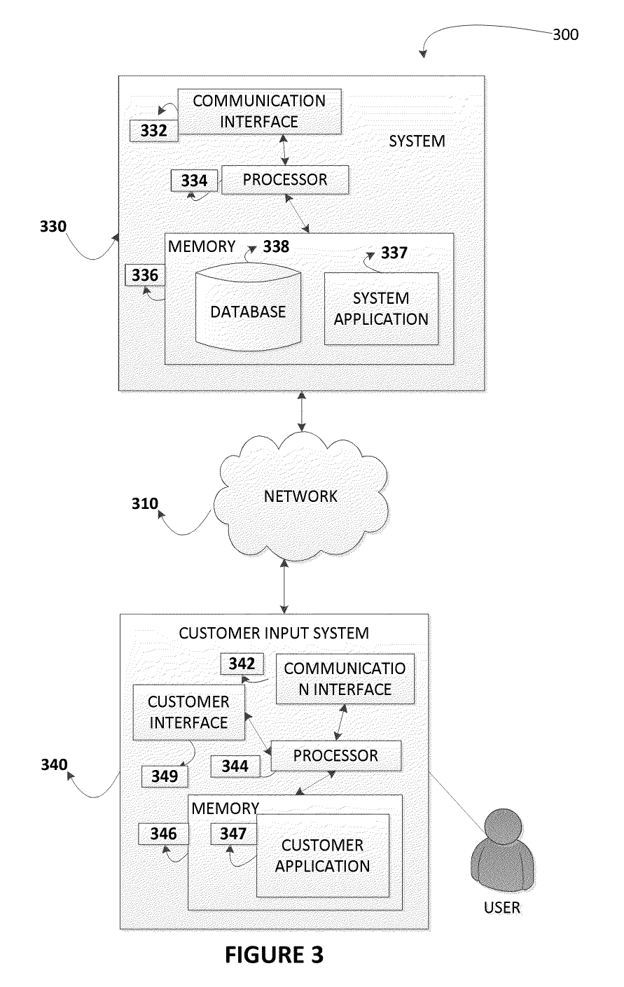

FIG. 3 presents an exemplary block diagram of the system environment 300 for implementing the process flows described herein in accordance with embodiments of the present invention. As illustrated, the system environment 300 includes a network 310, a system 330, and a user input system 340. Also shown in FIG. 3 is a user of the user input system 340. The user input system 340 may be a mobile device or other non-mobile computing device. For purposes of the invention, the customer input system 340 is a virtual reality server capable of configuring a three dimensional (3D) representation of an environment. The user may be a person who uses the user input system 340 to execute a user application 347. The user application 347 may be an application to communicate with the system 330, perform a transaction, input information onto a user interface presented on the user input system 340, or the like. The user application 347 and/or the system application 337 may incorporate one or more parts of any process flow described herein.

As shown in FIG. 3, the system 330, and the user input system 340 are each operatively and selectively connected to the network 310, which may include one or more separate networks. In addition, the network 310 may include a telecommunication network, local area network (LAN), a wide area network (WAN), and/or a global area network (GAN), such as the Internet. It will also be understood that the network 310 may be secure and/or unsecure and may also include wireless and/or wired and/or optical interconnection technology.

The user input system 340 may include any computerized apparatus that can be configured to perform any one or more of the functions of the user input system 340 described and/or contemplated herein. For example, the user may use the user input system 340 to transmit and/or receive information or commands to and from the system 330. In some embodiments, for example, the user input system 340 may include a personal computer system (e.g. a non-mobile or non-portable computing system, or the like), a mobile computing device, a personal digital assistant, a mobile phone, a tablet computing device, a network device, and/or the like. As illustrated in FIG. 3, in accordance with some embodiments of the present invention, the user input system 340 includes a communication interface 342, a processor 344, a memory 346 having an user application 347 stored therein, and a user interface 349. In such embodiments, the communication interface 342 is operatively and selectively connected to the processor 344, which is operatively and selectively connected to the user interface 349 and the memory 346. In some embodiments, the user may use the user application 347 to execute processes described with respect to the process flows described herein. Specifically, the user application 347 executes the process flows described herein.

Each communication interface described herein, including the communication interface 342, generally includes hardware, and, in some instances, software, that enables the user input system 340, to transport, send, receive, and/or otherwise communicate information to and/or from the communication interface of one or more other systems on the network 310. For example, the communication interface 342 of the user input system 340 may include a wireless transceiver, modem, server, electrical connection, and/or other electronic device that operatively connects the user input system 340 to another system such as the system 330. The wireless transceiver may include a radio circuit to enable wireless transmission and reception of information. Additionally, the user input system 340 may include a positioning system. The positioning system (e.g. a global positioning system (GPS), a network address (IP address) positioning system, a positioning system based on the nearest cell tower location, or the like) may enable at least the user input system 340 or an external server or computing device in communication with the user input system 340 to determine the location (e.g. location coordinates) of the user input system 340.

Each processor described herein, including the processor 344, generally includes circuitry for implementing the audio, visual, and/or logic functions of the user input system 340. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 347 of the memory 346 of the user input system 340.

Each memory device described herein, including the memory 346 for storing the user application 347 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 3, the memory 346 includes the user application 347. In some embodiments, the user application 347 includes an interface for communicating with, navigating, controlling, configuring, and/or using the user input system 340. In some embodiments, the user application 347 includes computer-executable program code portions for instructing the processor 344 to perform one or more of the functions of the user application 347 described and/or contemplated herein. In some embodiments, the user application 347 may include and/or use one or more network and/or system communication protocols.

Also shown in FIG. 3 is the user interface 349. In some embodiments, the user interface 349 includes one or more output devices, such as a display and/or speaker, for presenting information to the user. In some embodiments, the user interface 349 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 349 includes the input and display devices of a mobile device, which are operable to receive and display information.

FIG. 3 also illustrates a system 330, in accordance with an embodiment of the present invention. The system 330 may refer to the “apparatus” described herein. The system 330 may include any computerized apparatus that can be configured to perform any one or more of the functions of the system 330 described and/or contemplated herein. In accordance with some embodiments, for example, the system 330 may include a computer network, an engine, a platform, a server, a database system, a front end system, a back end system, a personal computer system, and/or the like. Therefore, the system 330 may be a server managed by the entity. The system 330 may be located at the facility associated with the entity or remotely from the facility associated with the entity. In some embodiments, such as the one illustrated in FIG. 3, the system 330 includes a communication interface 332, a processor 334, and a memory 336, which includes a system application 337 and a structured database 338 stored therein. As shown, the communication interface 332 is operatively and selectively connected to the processor 334, which is operatively and selectively connected to the memory 336.

It will be understood that the system application 337 may be configured to implement any one or more portions of the various user interfaces and/or process flow described herein. The system application 337 may interact with the user application 347. It will also be understood that, in some embodiments, the memory includes other applications. It will also be understood that, in some embodiments, the system application 337 is configured to communicate with the structured database 338, the user input system 340, or the like.

It will be further understood that, in some embodiments, the system application 337 includes computer-executable program code portions for instructing the processor 334 to perform any one or more of the functions of the system application 337 described and/or contemplated herein. In some embodiments, the system application 337 may include and/or use one or more network and/or system communication protocols.

In addition to the system application 337, the memory 336 also includes the structured database 338. As used herein, the structured database 338 may be one or more distinct and/or remote databases. In some embodiments, the structured database 338 is not located within the system and is instead located remotely from the system. In some embodiments, the structured database 338 stores information or data described herein.

It will be understood that the structured database 338 may include any one or more storage devices, including, but not limited to, datastores, databases, and/or any of the other storage devices typically associated with a computer system. It will also be understood that the structured database 338 may store information in any known way, such as, for example, by using one or more computer codes and/or languages, alphanumeric character strings, data sets, figures, tables, charts, links, documents, and/or the like. Further, in some embodiments, the structured database 338 may include information associated with one or more applications, such as, for example, the system application 337. It will also be understood that, in some embodiments, the structured database 338 provides a substantially real-time representation of the information stored therein, so that, for example, when the processor 334 accesses the structured database 338, the information stored therein is current or substantially current.

It will be understood that the embodiment of the system environment illustrated in FIG. 3 is exemplary and that other embodiments may vary. As another example, in some embodiments, the system 330 includes more, less, or different components. As another example, in some embodiments, some or all of the portions of the system environment 300 may be combined into a single portion. Likewise, in some embodiments, some or all of the portions of the system 330 may be separated into two or more distinct portions.

In addition, the various portions of the system environment 300 may be maintained for and/or by the same or separate parties. It will also be understood that the system 330 may include and/or implement any embodiment of the present invention described and/or contemplated herein. For example, in some embodiments, the system 330 is configured to implement any one or more of the embodiments of the process flows described and/or contemplated herein in connection any process flow described herein. Additionally, the system 330 or the user input system 340 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for providing a virtual banking experience using a wearable computing device, whereby the wearable computing device allows the customer to interact with a financial institution, the system comprising:
a wearable computer apparatus including one or more computing processors, a memory, and a display, wherein the wearable computer apparatus comprises an optical head-mounted display (OHMD) configured to present image information or multimedia information to the customer;
a module stored in the memory, the module comprising computer-executable instructions that when executed by the one or more processors cause the system to:
receive an indication that the customer desires to initiate a virtual banking session using the OHMD;
receive from the customer a selection of a real agent or a virtual agent for conducting the virtual banking session;
configure a virtual banking environment comprising one or more virtual objects for facilitating the virtual banking session, wherein the virtual banking environment comprises one or more virtual objects associated with one or more financial institution products and/or services; and
implement, via the OHMD, the virtual banking session involving the customer and the customer-selected real agent or the customer-selected virtual agent.

2. The system of claim 1, further comprising:
a partitioned area providing a degree of privacy to the customer for conducting the virtual banking session, wherein the partitioned area comprises one or more OHMDs and one or more devices that are used in combination with the one or more OHMDs to facilitate the virtual banking session.

3. The system of claim 2, wherein the partitioned area is capable of communicating with one or more OHMDs not associated with the partitioned area, wherein communicating further comprises synchronizing the one or more OHMDs not associated with the partitioned area with the one or more devices to be used in combination with the one of more OHMDs not associated with the partitioned area to facilitate the virtual banking session.

4. The system of claim 2, wherein the partitioned area is capable of being dynamically set up and remotely connected to the financial institution.

5. The system of claim 1, wherein the module is further configured to receive, via the OHMD, authentication information from the customer authenticating the virtual banking session.

6. The system of claim 5, wherein the module is further configured to automatically populate the display with one or more virtual objects relating to one or more financial accounts of the customer based at least partially on receiving authentication information that successfully authenticates the customer.

7. The system of claim 6, wherein the one or more virtual objects relating to the one or more financial accounts of the customer are selectable within the virtual banking session by either the customer or the customer-selected real agent or the customer-selected virtual agent for conducting a transaction during the virtual banking session.

8. The system of claim 1, wherein the module is further configured to implement an unauthenticated virtual banking session, wherein only one or more virtual objects relating to information about products or services of the financial institution are populated to the display.

9. The system of claim 1, wherein the module is further configured to display the customer-selected real agent or the customer-selected virtual agent within the virtual banking environment, wherein the customer-selected real agent or the customer-selected virtual agent interact with the customer, and wherein the customer-selected real agent or the customer-selected virtual agent provide responses to one or more queries of the customer.

10. The system of claim 9, wherein the module is configured to enable customer-selected real agent to interact with the customer by at least one of a voice via a microphone, a video via a webcam, and/or an instant messaging client.

11. A method for providing a virtual banking experience using a wearable computing device, whereby the wearable computing device allows the customer to interact with a financial institution, the method comprising:
receiving, using a computing device processor, an indication that the customer desires to initiate a virtual banking session using the OHMD;
receiving, using a computing device processor, from the customer a selection of a real agent or a virtual agent for conducting the virtual banking session;
configuring, using a computing device processor, a virtual banking environment comprising one or more virtual objects for facilitating the virtual banking session, wherein the virtual banking environment comprises one or more virtual objects associated with one or more financial institution products and/or services; and
implementing, using a computing device processor, via the OHMD, the virtual banking session involving the customer and the customer-selected real agent or the customer-selected virtual agent.

12. The method of claim 11, wherein configuring the virtual banking environment further comprises configuring a partitioned area for providing a degree of privacy to the customer for conducting the virtual banking session, wherein the partitioned area comprises one or more OHMDs and one or more devices that are used in combination with the one or more OHMDs to facilitate the virtual banking session.

13. The method of claim 11, wherein receiving further comprises receiving, via the OHMD, authentication information from the customer authenticating the virtual banking session.

14. The method of claim 11, wherein implementing further comprises implementing an unauthenticated virtual banking session, wherein only one or more virtual objects relating to information about products or services of the financial institution are populated to the display.

15. The method of claim 11, wherein configuring further comprises displaying the customer-selected real agent or the customer-selected virtual agent within the virtual banking environment, wherein the customer-selected real agent or the customer-selected virtual agent interact with the customer, and wherein the customer-selected real agent or the customer-selected virtual agent provide responses to one or more queries of the customer.

16. The method of claim 15, wherein implementing the virtual banking session further comprises enabling the customer-selected real agent to interact with the customer by at least one of a voice via a microphone, a video via a webcam, and/or an instant messaging client.

17. A computer program product for providing a virtual banking experience using a wearable computing device, whereby the wearable computing device allows the customer to interact with a financial institution, the computer program product comprising a non-transitory computer-readable medium comprising code causing a first apparatus to:
receive an indication that the customer desires to initiate a virtual banking session using the OHMD;
receive from the customer a selection of a real agent or a virtual agent for conducting the virtual banking session;
configure a virtual banking environment comprising one or more virtual objects for facilitating the virtual banking session, wherein the virtual banking environment comprises one or more virtual objects associated with one or more financial institution products and/or services; and
implement, via the OHMD, the virtual banking session involving the customer and the customer-selected real agent or the customer-selected virtual agent.

18. The computer program product of claim 17, wherein the first apparatus is further configured to receive, via the OHMD, authentication information from the customer authenticating the virtual banking session.

19. The computer program product of claim 17, wherein the first apparatus is further configured to implement an unauthenticated virtual banking session, wherein only one or more virtual objects relating to information about products or services of the financial institution are populated to the display.

20. The computer program product of claim 17, wherein the first apparatus is further configured to automatically populate the display with one or more virtual objects relating to one or more financial accounts of the customer based at least partially on receiving authentication information that successfully authenticates the customer.
